(19) United States
(12) Patent Application Publication
(10) Pub. No.: US 2007/0102835 A1
(43) Pub. Date: May 10, 2007

(54) AUTOMATED IN-LINE MOULDING/HEATING PROCESS AND APPARATUS FOR PREPARING CONTACT LENSES

(75) Inventors: William J. Appleton, Rochester, NY (US); Joseph D. Blasiak, Fairport, NY (US); Sanjay Rastogi, Rochester, NY (US)

Correspondence Address: Bausch & Lomb Incorporated, One Bausch & Lomb Place, Rochester, NY, 14604-2701, US

(73) Assignee: BAUSCH & LOMB INCORPORATED, Rochester, NY (US)

(21) Appl. No.: 11/164,100

(22) Filed: Nov. 10, 2005

(51) Int. Cl. B29D 11/00

(52) U.S. Cl. 264/1.32; 425/808; 425/254

(57) ABSTRACT

Method and apparatus for preparing a silicone hydrogel lens including heating a cast lens to drive off an organic diluent by moving the cast lens continuously through heating and cooling zones to provide a first-in-first-out handling system. The zones are either horizontally or vertically arranged. An apparatus embodiment of a vertical heating zone includes outer and inner concentric shells arranged in a heating chamber. One of the shells rotates about a vertical axis relative to the other. The outer shell has a spiral rail extending into the space between the outer and inner shells and the inner shell has a plurality of vertical ribs spaced about its periphery. A lens carrier placed on the rail is engaged and driven along the spiral rail by one of the ribs responsive to the relative motion between the outer and inner shells.

### FIELD OF THE INVENTION

The present invention relates to an in-line process for preparing contact lenses. More particularly, the present invention relates to an in-line process continuous process for making contact lenses and in particular, silicone containing hydrogel lenses.

### BACKGROUND OF THE INVENTION

Processes for making contact lenses and in particular silicone hydrogel lenses are well known in the art. Reference is made to U.S. Pat. No. 5,260,000, the disclosure of which is incorporated herein by reference, for a description of a typical process for producing such lenses.

Briefly, the current practice involves the preparation of a mixture of a silicone-containing monomer, a hydrophilic monomer and an organic diluent. This mixture is cast into a mold and cured or polymerized to obtain a shaped lens article. The lens article, still retained in the mold is placed in an oven and maintained at an elevated temperature for a time sufficient to drive off the organic diluent that may be entrapped within the polymerized lens matrix. After cooling, the article is removed from the mold and subjected to further treatments to produce the contact lens.

Current manufacturing processes use a batch oven process for heating to remove the organic diluent. Such batch heating requires dedicated and mostly manual material handling techniques to load and unload the heating oven. Batch trays also are dedicated for parts handling and orientation within the heating oven. In a typical batch operation, trays containing a plurality of the molds are stacked in a forced air oven and are kept in the oven for up to three hours at 60° C. in order to remove the organic diluent.

Accordingly, to date, the production of silicone hydrogel contact lenses has been labor intensive first to manually load a plurality of molds onto a dedicated tray, then to manually load a plurality of individual trays into the heating oven and then to manually unload the trays from the oven.

Accordingly, it is an object of the present invention to provide a method of producing silicone hydrogel lenses that reduces the amount of manual handling as opposed to the current batch method.

Another object is to provide a method that provides a first-in-first out product flow.

A further object is to provide a method that provides for the continuous movement of molds or batches of molds through a heating/cooling chamber.

### BRIEF SUMMARY OF THE INVENTION

In accordance with the present invention, the molds containing the polymerized silicone hydrogel are arranged in trays placed on a moving conveyor. The conveyor moves along a path of travel that extends into and through a heating chamber. The speed of the conveyor, the size of the chamber and the temperature control are all selected to provide a residence time and temperature conditions within the camber sufficient to drive off the organic diluent from the polymerized silicone hydrogel. The path of the conveyer subsequently carries the trays through a cooling zone and then through a treating zone where lenses are removed from the molds for further treatment.

The heating chamber can be horizontally oriented with the cooling zone located downstream along a horizontal path of travel. In an alternative arrangement the heating chamber is vertically oriented so heating occurs during ascent through the heating chamber and cooling occurs on the subsequent descent.

In one embodiment, a plurality of individual molds each containing a silicone hydrogel article are placed in trays which are then placed on the conveyor for travel through the heating and cooling chambers. An alternative is to pass individual molds continuously through the heating and cooling chambers.

Accordingly, the present invention may be characterized in one aspect thereof by a method for producing a shaped ophthalmic biomedical article blank such as a silicone hydrogel contact lens or the like comprising:

a) casting a curable liquid formulation including an organic diluent into a mold;

b) curing the liquid formulation within the mold to form the article blank;

c) conveying the article blank and the mold along a path of travel extending through a heating zone, the conveying allowing the article blank and the mold to remain in the heating zone for a time sufficient to drive off the organic diluent and produce a substantially diluent-free article blank within the mold; and

d) moving the article blank and the mold from the heating zone and along the path of travel through a subsequent treating zone to further treat the substantially diluent-free article blank within the mold.

### BRIEF DESCRIPTION OF THE SEVERAL VIEWS OF THE DRAWING(S)

FIG. 1 is a schematic representation of the steps in the method of the present invention wherein the heating and cooling zones are horizontally oriented;

FIG. 2 is a schematic view showing another apparatus for implementing the method of the present invention wherein the heating and cooling zones are vertically oriented;

FIG. 3 is a schematic view of one embodiment of a vertically oriented heating chamber for practicing the method of the present invention;

FIG. 4 is a plan view of a portion of the Figure;

FIG. 5 is a view taken along lines 5-5 of FIG. 4; and

FIG. 6 is a view taken along lines 6-6 of FIG. 4.

### DETAILED DESCRIPTION OF THE INVENTION

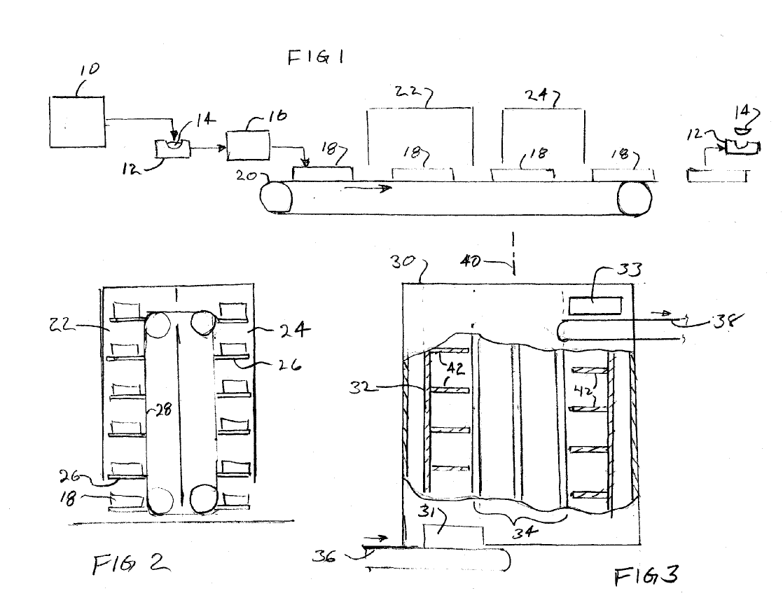

Referring to the drawings, FIG. 1 shows the steps in the method of the present invention. As a first step a composition is prepared for casting an ophthalmic biomedical article wherein the composition contains an organic diluent.

In the context of the present invention the article is a silicone hydrogel lens. A composition and method for making a silicone hydrogel lens are known in the art and reference is made to the composition and method as described in U.S. Pat. No. 5,260,000, the disclosure of which is incorporated herein by reference. Briefly, and as stated in U.S. Pat. No. 5,260,000, a monomeric mixture is prepared comprising a silicone-containing monomer, a hydrophilic monomer and an organic diluent.

This mixture 10 as shown in FIG. 1 is then charged into a mold 12 having the desired shape of the article to be formed, in this case a silicone hydrogel lens blank 14. The mixture charged into the mold is cured as shown at 16. Curing preferably involves exposure of the mixture in the mold to ultraviolet light to initiate the polymerization of the monomers in the mixture.

After cure is complete, the lens blanks still in the mold 12 is heated to drive off the organic diluent. In the embodiment of the invention as shown in FIG. 1, this involves placing a plurality of the molds into a holding tray 18. In this respect upwards of 150 or more of the molds, each containing a single lens blank, are placed into each tray. The tray 18 then is placed onto a conveyor 20 that carries the tray along a horizontal path of travel first through a heating zone 22 and then a cooling zone 24. While the Figure shows trays 18 being arranged in a single file on the conveyor, it should be appreciated that the conveyor can be wide enough to accommodate two or more trays side-by-side to increase the capacity and the production rate.

Progress of the tray 18 is continuous and other trays 18 are added to the conveyor as the mixture in additional individual molds 12 go through a curing step. The speed of the conveyor along its horizontal path of travel together is sufficient to allow each tray to remain in the zone 22 for a time sufficient to drive off the organic diluent from the cast lenses. In this respect, the size of the heating zone 22 and the temperature/air flow parameters within the heating zone are selected so these parameters together with the linear speed of the conveyor allow for the appropriate residence time.

After passage through the heating zone 22, the conveyor carries the trays 18 through the cooling zone 24. Upon passage thought the cooling zone, the trays are removed from the conveyor and emptied. Individual molds 12 then are treated to effect the removal of the cast article 14.

In the embodiment of FIG. 2 the conveyor is arranged to travel through a vertical path of travel. In this respect FIG. 2 shows that a tray 18 containing a plurality of molds (not shown) enters the heating zone 22 at a low level and is placed on a shelf 26. The ends of the shelf are attached to an endless drive chain or belt 28 that move the shelves vertically through the heating zone. At an upper level of the heating zone the endless belts start on a downward path that extends through a cooling zone 24.

Suitable mechanisms for maintaining the trays horizontal during the transition from upward to downward travel (and from downward to upward travel) are known in the art. Trays 18, upon reaching the bottom or end of the cooling zone are removed from the shelves are then transferred to a horizontal path for conveying to a station where the lenses are separated from the molds.

FIGS. 3-6 illustrate a still further vertically oriented embodiment of the invention. FIG. 3 shows a heated chamber 30. Within the heated chamber are two vertically oriented cylindrical shells. The shells are concentric and include an outer shell 32 and an inner shell 34. The heating chamber includes various components, not shown, including heating elements, fans for convection heating, insulation to retain heat, filters for incoming air and provisions to exhaust waste air. It should be understood that the appropriate temperature controls also are provided.

Also associated with the heating chamber 30 are load/unload systems for moving molds to be heated into the heating chamber through a bottom located inlet 31 and out of the chamber through a top located outlet 33. The load/unload systems are schematically represented in FIG. 3 by an inlet conveyor 36 and an outlet conveyor 38 respectively.

The outer and inner shells 32, 34 are vertically oriented and one of the shells rotates about a vertical axis 40 relative to the other. For purposes of description the apparatus will be described as if the inner shell 34 rotates and the outer shell 32 is fixed.

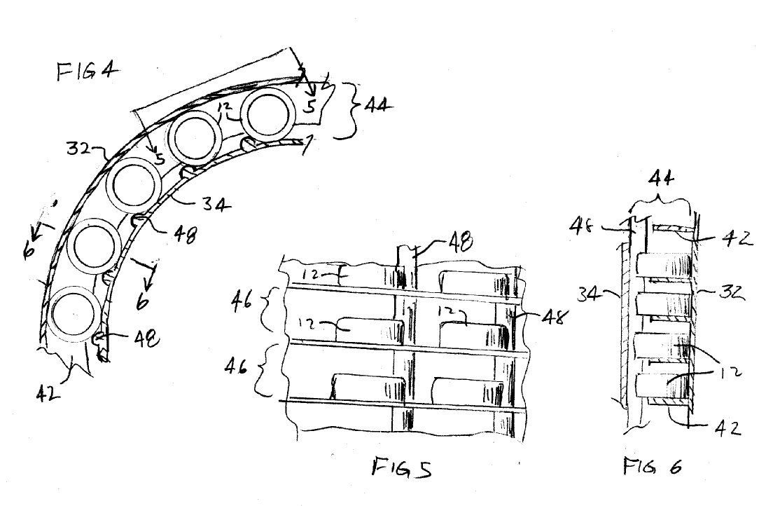

Fixed to the outer shell 32 and extending inward from the inner surface of the outer shell is a helical rail 42. As best seen in FIGS. 4 and 6, the rail 42 spans a portion of the space 44 between the inner and outer shells but does not extend to the inner shell. The rail spirals upwards along the outer shell with the helical pitch or spacing 46 between adjacent portions of the rail being constant (FIG. 5).

Provided on the outer surface of the inner shell 34 are vertically oriented ribs 48. These ribs are at equally spaced intervals around the periphery of the inner shell. As noted hereinabove, the helical rail 42 does not extend to the inner shell. Accordingly there is a space between the rail and the surface of the ribs so the ribs pass close to, but do not contact the rail.

In the context of one embodiment, the relationship between the diameter of a mold 12 and the space 44 between the outer and inner shells 32, 34 is critical. In this respect, and as best seen in FIGS. 4 and 6, the diameter of each mold 12 is less than the width of the distance across the space 44 but greater than the width of the helical rail so a mold will over hang the edge of the rail. The diameter of each mold also is greater than the distance between the outer shell 32 and the crown of the ribs 48.

In operation, a first of the molds 12 that contains the cast article for heating is loaded through the bottom located inlet 31 and onto the lowermost portion of the helical rail 42. As the inner cylindrical shell 34 rotates in a continuous or stepwise fashion, one of the vertical ribs 48 engages the mold on the rail and pushes the mold along the helical rail. Movement of the mold is constrained by the inner surface of the outer shell 32 so the mold is forced to move up the helical rail.

Now, when a second mold is loaded through the inlet 31 and onto the helical rail, the rotation or step wise indexing of the inner shell 34 brings a following rib 48 into engagement with the second mold and moves it along the helical rail. In this fashion molds are loaded sequentially onto the helical rail and are moved progressively, either continuously or step wise, upwardly along the helical rail and through the heating zone represented by the heating chamber 30.

The angle of inclination of the helical rail 42, the pitch 46 of the rail and the timing of the rotation of the inner shell 34 determine the overall time the molds 12 take to travel through the heating chamber. As with the previous embodiments, this time, considered the residence time of the molds within the heating chamber 30, is sufficient to drive off the organic diluent component of the lens forming mixture. Upon leaving through the outlet 33 the heated molds are conveyed through a cooling zone after which the lens is separated from the mold for further operations.

In a typical batch operation of the prior art, two hours of production may involve the handling and processing of upwards of 1500 individual molds. With an apparatus as shown in FIGS. 3-6, the production volume becomes a function of mold diameter, mold height, the diameter of the stationary outer shell 32, and the helical pitch of the rail 42. Given current mold dimensions, the same two hours of batch operation can be accommodated in a chamber that has a mold center-to-mold center of 24 inches and that is 20 inches tall.

Accordingly, the method and apparatus of the present invention provides an improved method and apparatus for heating the silicone hydrogel lenses to drive off the organic diluent. The invention further provides an inventory management system that is a true first-in-first-out system as opposed to a batch operation and that has a larger through put than the conventional batch operation.

Accordingly, it should be appreciated that the present invention accomplishes its intended objects by providing a method of producing silicone hydrogel lenses that reduces the amount of manual handling as opposed to the current batch method. The present invention further provides a method and apparatus that allows for a first-in-first out product flow and that provides for the continuous movement of molds or batches of molds through a heating /cooling chamber.

What is claimed is:

1. A method producing a shaped ophthalmic biomedical article blank comprising:
a) casting a curable liquid formulation including an organic diluent into a mold;
b) curing the liquid formulation within the mold to form the article blank;
c) conveying the article blank and the mold along a path of travel extending through a heating zone, the conveying allowing the article blank and the mold to remain in the heating zone for a time sufficient to drive off the organic diluent and produce a substantially diluent-free article blank within the mold; and
d) moving the article blank and the mold from the heating zone and along the path of travel through a subsequent treating zone to further treat the substantially diluent-free article blank within the mold.

2. A method as in claim 1 wherein the subsequent treating zone is a cooling zone and allowing the substantially diluent-free article blank and mold to remain in the cooling zone for a time sufficient to allow the dry separation of the article blank form the mold.

3. A method as in claim 1 wherein the curable liquid formulation is a silicone hydrogel contact lens formulation.

4. A method as in claim 1 wherein the conveying step comprises placing a plurality of the molds and article blanks in a carrier and continuously moving the carrier with its plurality of molds and blanks through the heating zone and then through the subsequent treating zone.

5. A method as in claim 4 wherein the path of travel through the heating zone is a along horizontal path of travel.

6. A method as in claim 5 wherein the subsequent treating zone is a cooling zone arranged along the horizontal path of travel and allowing the substantially diluent-free article blank and mold to remain in the cooling zone for a time sufficient to allow the dry separation of the article blank form the mold.

7. A method as in claim 4 wherein the path of travel through the heating zone is a along a vertical path of travel.

8. A method as in claim 7 wherein the subsequent treating zone is a cooling zone and allowing the substantially diluent-free article blank and mold to remain in the cooling zone for a time sufficient to allow the dry separation of the article blank form the mold.

9. A method as in claim 8 comprising arranging the heating zone along a first vertically oriented path of travel and arranging the cooling zone along a second vertically oriented path of travel.

10. A method as in claim 1 comprising arranging a plurality of molds including the article blanks therein one after another and passing the molds in sequence through a spiral path of travel within the heating zone.

11. A method as in claim 10 wherein:
a) the spiral path of travel through the heating zone is defined between concentric inner and outer cylindrical walls;
b) rotating one of the walls; and
c) engaging each mold with a drive member fixed to the rotatable wall for driving the molds along the spiral path.

12. A method producing a shaped ophthalmic biomedical article blank comprising:
a) casting a curable liquid formulation including an organic diluent into a mold;
b) curing the liquid formulation within the mold to form the article blank;
c) aligning a plurality of the article blank-containing molds one after another and continuously moving them along a spiral path of travel defined between concentric inner and outer cylinders, the spiral path including a heating zone;
d) maintaining the molds in the heating zone for a time sufficient to drive off the organic diluent from the article blank and produce a substantially diluent-free article blank within each mold; and
e) further treating the molds and diluent-free article blanks to facilitate the dry separation of the diluent-free article blanks from the molds.

13. A method as in claim 12 wherein further treating comprises cooling the molds upon leaving the heating zone.

14. A method as in claim 12 comprising moving the molds along the spiral path by rotating the inner cylinder and engaging each mold with a member fixed to the inner cylinder.

15. Apparatus for producing a shaped ophthalmic biomedical article including a heating zone and means for moving the article through the heating zone comprising:
a) an inner and an outer vertically arranged concentric shells, the shells defining a space therebetween and one of the inner and outer shells being rotatable about a vertical axes relative to the other;
b) a helical rail carried by the outer shell, the helical rail extending horizontally from the inner surface of the outer shell into the space between the outer and inner shells and spiraling upwardly along the height of the outer shell;
c) vertically extending ribs on the inner shell at spaced intervals about the periphery of the inner shell, the ribs having a crown that extends into the space between the outer and inner shells; and
d) the width of the rail being shorter than the space between the outer shell and the crown of the ribs.

16. Apparatus as in claim 15 wherein the inner and outer shells are disposed within a heating chamber having a bottom located entry for the articles to be heated and a top located outlet for the articles.

17. Apparatus as in claim 16 wherein the articles are cast silicone hydrogel lenses each lens being contained in a circular casting mold wherein the space between the outer and inner shells has a width equal to the diameter of the circular mold and the ribs on the inner shell contacting the mold and driving the mold upward along the helical rail responsive to the rotation of one of the outer and inner shells relative to the other.

18. Apparatus as in claim 17 wherein the inner shell is rotatably driven and the outer shell is fixed.
